(19) United States
(12) Patent Application Publication
(10) Pub. No.: US 2024/0168726 A1
(43) Pub. Date: May 23, 2024

(54) Node diagram interface for designing data pipelines from arbitrary computer instructions

(71) Applicant: Saeed Gholamian, Seneca, SC (US)

(72) Inventor: Saeed Gholamian, Seneca, SC (US)

(21) Appl. No.: 18/513,427

(22) Filed: Nov. 17, 2023

Related U.S. Application Data
(60) Provisional application No. 63/384,426, filed on Nov. 19, 2022.

(51) Int. Cl. G06F 8/34

(52) U.S. Cl. CPC G06F 8/34

(57) ABSTRACT

A computer-implemented method and system of constructing a node diagram interface for designing data pipelines from arbitrary instructions displaying, through graphical user interface, at least one code view representing the code associated with one or more instruction, at least one diagram view representing the code associated with one or more instruction, and at least one visual representation of one or more pipeline connection; and programmatically extracting one or more pipeline design configuration from at least one diagram view. In embodiments the instructions may be depicted in a diagram as visual nodes with at least one inlet for entering data into the node or at least one outlet for exporting data from the node, such that the configuration of the inlets, outlets, and pipeline connections visualizes the expected flow of the diagram.

### RELATED APPLICATIONS

This application claims priority under 35 U.S.C. § 120 as a continuation of U.S. application Ser. No. 63/384,426, entitled, “A node graph interface for designing data pipelines from arbitrary computer instructions” filed on Nov. 19, 2022.

### BACKGROUND OF THE INVENTION

Computer instructions such as in the form of human readable codes and executable binaries may be interconnected in a variety of arrangements to create different computer programs. One such arrangement is a data pipeline in which the output of an instruction is used as the input of the next instruction. The extent to which the corresponding inputs and outputs are compatible with each other and the number of ways in which instructions may be interconnected can contribute to the complexity of pipeline design. The compatibility and connectivity configurations may be hard coded into the pipeline. However, this approach inhibits the pipeline's modularity and flexibility by explicitly delineating the structure and flow of data. Decoupling the instructions from their configurations can improve the modularity and flexibility of pipelines. Such a decoupling can be achieved by interfacing the instructions with sufficiently detailed representations of their compatibility and connectivity which allows for any arbitrary instructions to be incorporated.

Therefore, there is a need in the art for methods and systems to decouple the compatibility and connectivity configurations from computer instructions in data pipelines.

### SUMMARY OF THE INVENTION

In an aspect, a computer-implemented method of constructing a node diagram interface for designing data pipelines from arbitrary instructions may include displaying, through graphical user interface, at least one code view representing the code associated with one or more instruction, at least one diagram view representing the code associated with one or more instruction, and at least one visual representation of one or more pipeline connection; and programmatically extracting one or more pipeline design configuration from at least one diagram view. In embodiments the instructions may be depicted in a diagram as visual nodes with at least one inlet for entering data into the node or at least one outlet for exporting data from the node, such that the configuration of the inlets, outlets, and pipeline connections visualizes the expected flow of the diagram.

In an aspect, a system for constructing a node diagram interface for designing data pipelines from arbitrary instructions may include a graphical user interface for displaying at least one code view representing the code associated with one or more instruction, at least one diagram view representing the code associated with one or more instruction, and at least one visual representation of one or more pipeline connection; and at least one computer program for extracting one or more pipeline design configuration from diagram views. In embodiments a diagram may display the instructions as visual nodes with at least one inlet for entering data into the node or at least one outlet for exporting data from the node, such that the expected flow of the diagram is visualized by the configuration of the inlets, outlets, and pipeline connections.

### BRIEF DESCRIPTION OF DRAWINGS

FIG. 1 depicts a view of an embodiment of a node diagram interface.

FIG. 2 depicts an additional view of an embodiment of a node diagram interface.

FIG. 3 depicts a view of an embodiment of a modified node diagram interface.

### DETAILED DESCRIPTION OF THE INVENTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In the context of the present disclosure, computer instruction (or simply “instruction”) is a component of software that contains information applicable to a process. Instructions may exist in a variety of forms such as human readable codes and executable binaries. Examples of computer instructions include a text in JSON format, a QR code image, cryptographic random bytes, and the Unix command “Is”. Instructions can be interconnected to form a data pipeline (or simply “pipeline”) that directs a series of sequential processes. Interfaces used for designing pipelines may be text-based or graphical. Text-based interfaces, such as the Unix shell “Bash” that features anonymous pipes, can allow a high level of flexibility in how data is modified and passed around. However, by intertwining the core instructions with the codes related to compatibility and connectivity logics, text-based interfaces offer limited modularity. For example, with such an interface, an instruction that expects a tab-separated text file as input cannot be replaced with one that expects a comma-separated input without introducing additional format conversion codes to amend the compatibility logic. Graphical pipeline design interfaces, such as “Unity Visual Scripting” (trademarked as Bolt™), address this problem by offering a curated set of purpose-built instructions exclusively made for the interface with built-in compatibility and connectivity configurations such that the instructions can be conveniently rearranged or replaced. However, the versatility of such a graphical interface is limited by the size of its curated list of instructions as it cannot make use of many off-the-shelf instructions. For example, such an interface may allow users to specify input files via drag-and-drop but not via the user's choice of off-the-shelf instructions such as the Unix command “Is”. Unlike purpose-built instructions that are deliberately made compatible with a pipeline design interface, most off-the-shelf instructions do not follow a universal standard for their compatibility and connectivity configurations. As a result, incorporating off-the-shelf instructions into pipelines requires either additional modifications or a fundamentally different pipeline design interface.

The node diagram interface described in the present disclosure (simply “the interface”) allows incorporating both purpose-built and off-the-shelf instructions (collectively “arbitrary instructions”) by integrating the compatibility and connectivity configurations into the interface independent of any instructions. This allows users to utilize a wide range of off-the-shelf instructions in addition to purpose-built instructions across various operating systems and environments.

In an embodiment, when a pipeline is deployed, the interface runs the primary instruction in the intended environment such as operating system or computing platform and records the outputs such as data in a file system or network. The primary instruction is one that does not rely on the outputs of other instructions. If there are more than one such instructions, they may run in parallel. The interface identifies all secondary instructions that are waiting for the output of the primary instruction(s). Once all input data of a secondary instruction are available to the interface, that instruction will run on its intended environment. For an instruction compatible with command line interface (CLI), this means that the output of the primary instructions will be used to fulfill the input arguments of a CLI command before that command is executed. A secondary instruction may require data from the outputs of more than one primary instruction, in which case all those primary instructions need to run first. This procedure continues until all instructions are processed by the interface. Using the interface as a proxy to capture and transfer data obviates the need to establish direct communication between the instructions. This approach allows for interconnecting instructions residing in environments that may be incompatible with or isolated from each other without having to embed additional compatibility and connectivity logics into the pipeline.

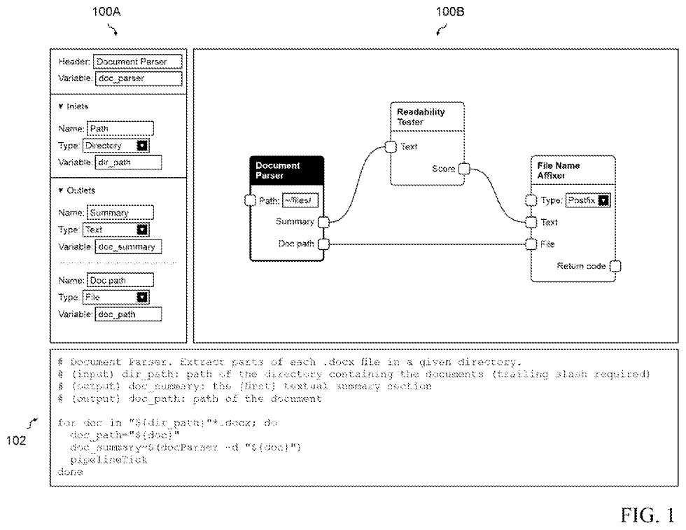

With reference to FIG. 1, a non-limiting example embodiment of the interface is depicted for designing a data pipeline. The example pipeline utilizes three nodes connected via three pipeline connections to extract the summary section of each DOCX document in a given directory, calculate the readability score of that summary, and append the score to the file name.

In this example embodiment, the right panel of the diagram view 100A-B displays a graphical representation of the instructions and includes three nodes illustrated as three rectangular shapes containing a header on the top and a body of vertically stacked rows for inlets and outlets depicted as square shapes. Inlets are located on the left border of a node and are the visual entry points of connections coming into the node, while outlets are located on the right border of the node and are the exit points of the connections going outside of the node. Each inlet and outlet row also includes a text and in two cases other interactive HTML elements to specify default inlet data in the absence of a connection. The three connections between the outlets and inlets of different nodes are depicted as lines connecting those inlets and outlets. The dark background of the header and thicker borders of the node on the left with the header “Document Parser” indicate that the information shown in other panels of the user interface relate to that particular node (in other words, that node is the currently selected node). For simplicity the description herein may generally refer to nodes by their header text.

In this example embodiment, the left panel of the diagram view 100A-B displays some of the configurations of the selected node, including the variables associated with each inlet and outlet that can be used in the code view 102 to access the data entering the inlets and exiting the outlets.

In this example embodiment, the code view 102 shows a text-based representation of the underlying instructions of the selected node including explanations of the code. The logic of the code involves looping through all the file paths within the input path that end with “.docx”. The input path is the data that the inlet receives. Since there is no connection entering the inlet, the default path set in the diagram view 100A-B will be used. Since the selected node has its required input available to it, once the pipeline is deployed, the underlying instructions associated with the selected node will take effect as follows. For each file in the loop, the path to the file will be assigned to the variable “doc_path” that represents the outlet named “Doc path”. An executable instruction named “docParser” will extract the summary section of the document and set the variable “doc_summary” that represents the outlet named “Summary” to the extracted summary text. An instruction named “pipelineTick” makes the output of each outlet available to their interconnected inlets before the next iteration occurs.

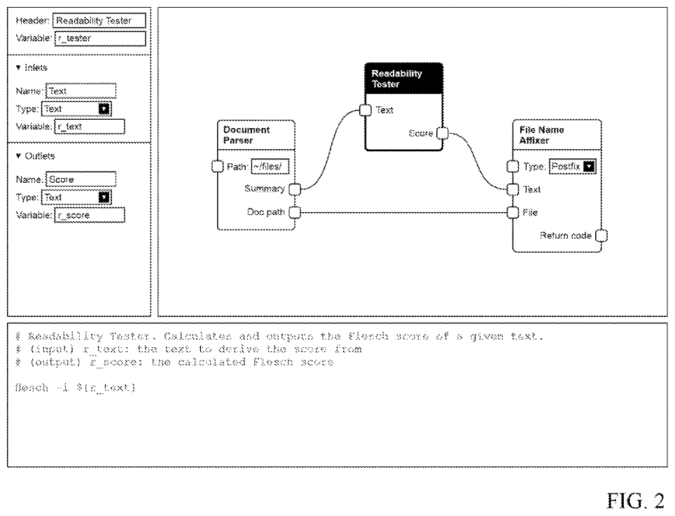

In this example embodiment, once the node “Readability Tester” receives its input data, its instructions will take effect to calculate a readability score of the summary section, pass that score to, and fulfill all input requirements of the node “File Name Affixer”, which in turn appends the score to the file name. FIG. 2 shows a view of the example embodiment when the node “Readability Tester” is selected.

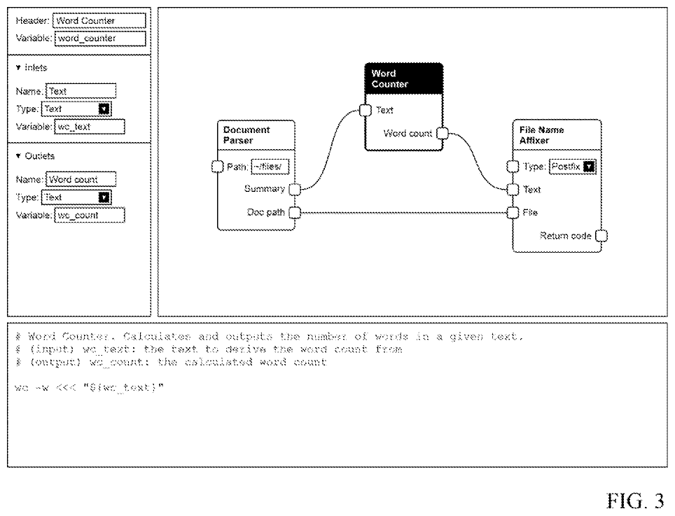

In this example embodiment, the node “Readability Tester” is likely to be substituted with any other nodes with logically compatible inlets and outlets for a variety of reasons, such as altering the functionality or performance of the pipeline. Such a substitution can be done by making a few changes to the configurations of the diagram view 100A-B and the code of the code view 102. FIG. 3 shows a view of the example embodiment in which the node “Word Counter” is used to substitute readability score with word count in file name affixes.

The aforementioned substitution example demonstrates one aspect of the modularity and flexibility of the interface in which most of the design configurations such as how a node processes an input, generates an output, and passes data to another node may remain unchanged after substitution and such configurations can be reused to design various pipelines. The underlying instructions associated with each node may be arbitrary in nature such that, for example, they do not have to be written in a specific programming language, have a specific structure, or be compatible with a specific platform. As an example, the underlying arbitrary instructions of the node “Word Counter” could be written in PHP language and run on a remote server while the other two nodes may have Bash instructions running on the local machine. Most common compatibility configurations such as those regarding exchanging data between a node on the local machine and a node on a remote server may not be depicted in the code view 102 by default as they are integrated into the interface. On the other hand, some additional instructions may be added to the core arbitrary instructions in the code view 102 such as the for-loop structure in FIG. 1.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4^{th} Generation (4G) networks (e.g. Long Term Evolution (LTE)) or 5^{th} Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method of constructing a node diagram interface for designing data pipelines from arbitrary instructions, comprising:
displaying at least one code view representing the code associated with one or more instruction;
displaying at least one diagram view representing the code associated with one or more instruction;
displaying at least one visual representation of one or more pipeline connection;
programmatically extracting one or more pipeline design configuration from at least one diagram view.

2. A system for constructing a node diagram interface for designing data pipelines from arbitrary instructions comprising a graphical user interface for:
displaying at least one code view representing the code associated with one or more instruction;
displaying at least one diagram view representing the code associated with one or more instruction;
displaying at least one visual representation of one or more pipeline connection.

3. The system of the claim 2, further comprising at least one computer program for extracting one or more pipeline design configuration from diagram views.
